(19) United States
(12) Patent Application Publication
(10) Pub. No.: US 2009/0068331 A1
(43) Pub. Date: Mar. 12, 2009

(54) Milk frother

(75) Inventor: Christian Muheim, Rickenbach (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Cafina AG, Hunzenschwil (CH)

(21) Appl. No.: 12/231,396

(22) Filed: Sep. 2, 2008

(30) Foreign Application Priority Data
Sep. 12, 2007 (CH) 01424/07

(51) Int. Cl. B01F 3/04; A23C 9/00; B01F 13/02; B01F 5/08; A47J 31/40

(52) U.S. Cl. 426/474; 99/285; 366/101; 366/146

(57) ABSTRACT

Proposed is a milk frother including a milk feed conduit (2), means (6) for heating the milk, as well as a blender element (1) provided with a main passageway (15) for blending the milk flowing through the main passageway (15). The blender element (1) comprises a base body (14) with a plurality of perforations porting into the main passageway (15). Via these perforations the frothing air is jetted into the throughflow of milk.

### BACKGROUND

The invention relates to a milk frother and to a method for creating milk froth.

Such devices find application especially in, or together with, espresso coffee machines. The milk froth created by the device is used, for example, in producing a cappuccino or latte.

A wealth of so-called emulsifiers is known for generating milk froth which generally feature a blender element provided with a steam feed conduit porting into a suction chamber. This suction chamber is connected to a milk feed conduit and an air feed conduit. By exploiting what is called the Venturi effect the flow of steam creates a negative pressure in the suction chamber causing the milk to be drawn into the suction chamber via the milk feed conduit and air via the air feed conduit. This steam/air/milk mixture is transformed into a turbulent flow in a subsequent emulsifier chamber, resulting in a hot emulsion of milk and air. Emulsifiers of this kind are known, for example, from EP-A-0 195 750 as well as from EP 0 858 757.

Since in the majority of known emulsifiers the air is jetted to a sole location, means need to be provided to subsequently blend the air and the milk into a homogenous milk froth.

### SUMMARY

It is thus one object of the invention to sophisticate a milk frother to make it capable of creating a high-quality milk froth without there being any need to follow the actual blender element with an emulsifier whilst rendering the frother compact and simply structured.

This object is achieved by the features as set forth in claim 1.

By providing the frother with a blender element comprising a base body with a plurality of perforations porting into the main passageway via which the frothing medium is jettable into the throughflow of milk a high-quality milk froth can now be created by simple ways and means. It has namely been discovered that automatically jetting minute quantities of air to innumerable locations results in a particularly high-quality milk froth which excels, among other things, by its homogenous, stable, firm and minute froth bubbles.

Preferred example aspects of the milk frother include the base body of the blender element being made of a hydrophobic and/or oleophobic material; and the diameter of the perforations porting into the main passageway are selected so that the throughflow of milk cannot enter thereinto under atmospheric conditions. In other aspects the base body defines in the main passageway a partition in which said perforations are machined; the base body is cylindrical; and the main passageway is machined in the base body and the base body is provided with an annular chamber surrounding the main passageway coaxially at least in part, the base body being made of a porous material so that the air jetted into the annular chamber can enter the main passageway via the pores. In still further aspects, the perforations porting into the main passageway having a maximum diameter of 0.3 mm; the base body of the blender element is made by sintering; the frother further comprises a pump for a pumped air feed, as well as an air filter circuited upstream of the pump; and the means for heating the milk includes an electrically operated continuous-flow heater and a temperature sensor for sensing the temperature of the heated milk.

Thus, for instance, in one preferred example aspect means for heating the milk are circuited upstream of the blender element which can now be supplied with heated milk which likewise contributes towards creating a high-quality milk froth.

In further embodiments, a method is provided for creating milk froth by a milk frother configured as set forth above. Preferred further embodiments of the method include the milk flowing through the blender element being jetted with air via a plurality of perforations; the milk being heated before being introduced into the blender element; and the blender element being jetted with air until the throughflow of the milk to be frothed through the blender element is stopped. In further features, the method includes the air being introduced via the perforations into the main passageway of the blender element before the blender element is supplied with the milk to be frothed and the air feed is not stopped until the throughflow of milk through the blender element has ceased; and before being introduced into the blender element the milk is heated to a temperature of at least 30° C., particularly to at least 60° C.

### DESCRIPTION OF THE FIGURES

Two embodiments of the invention will now be described with reference to the drawings in which:

FIG. 1 is a diagrammatic illustration of a first example aspect of a milk frother;

FIG. 1a is magnified view of a detail taken from FIG. 1; and

FIG. 2 is a diagrammatic illustration of a second example aspect of a milk frother

### DESCRIPTION OF THE EMBODIMENTS

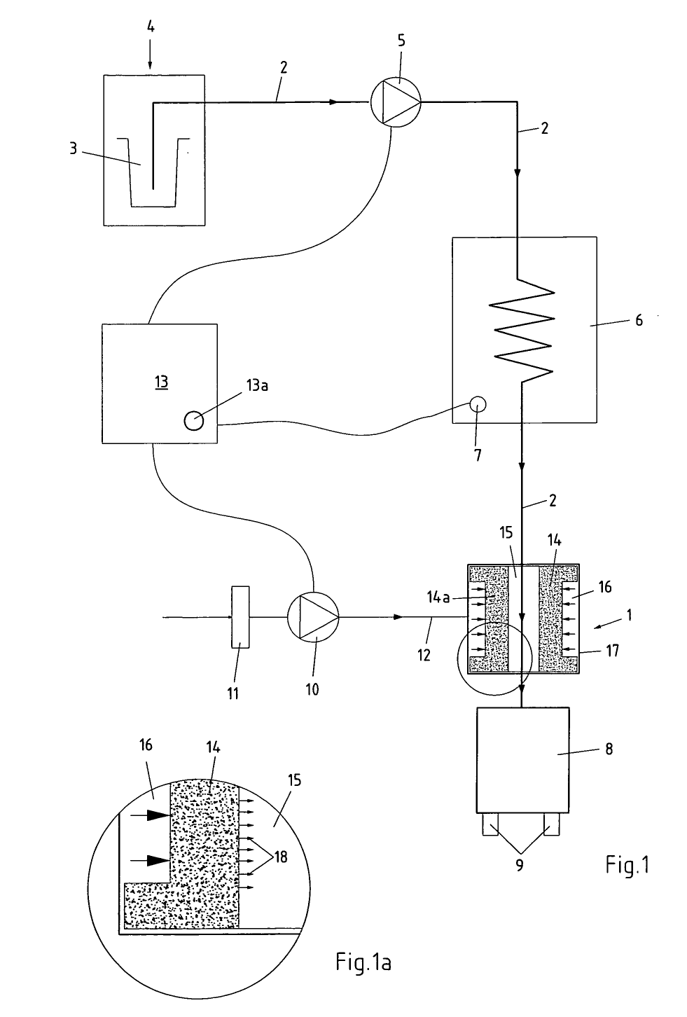

Referring now to FIG. 1 there is illustrated how the milk frother comprises a blender element 1 in which the throughflow of milk is jetted with air to froth the milk. The blender element 1 is connected by a milk feed conduit 2 to a milk receptacle 3 held in a chiller 4. For pumping the milk a milk pump 5 is provided followed by an electrically operated continuous-flow heater 6 to heat the milk. The continuous-flow heater 6 is provided with a temperature sensor 7, shown diagrammatically, by means of which the temperature of the milk heated in the continuous-flow heater 6 is sensed. By means of an air pump 10 air is jetted into the blender element 1 via a conduit 12. Circuited upstream of the pump 10 is an air filter 11 which may be engineered as a conventional mechanical filter or, for example, it may take the form of an active carbon filter. Provided furthermore is an electronic controller 13 which is electrically connected to the two pumps 5, 10 as well as to the continuous-flow heater 6 and temperature sensor 7 and serves to control the complete milk frother. The controller 13 features at least one button 13a for starting and stopping frothing. At the outlet end the blender element 1 is connected to a discharge element 8 comprising two outlets 9 via which frothed milk can emerge. This discharge element 8 may form a component of a coffee machine, it in this case may also serving as the outlet for the prepared coffee beverages. Instead of an electrically operated continuous-flow heater 6, other means may be provided for heating the milk, for example, by means of steam.

The blender element 1 comprises a base body 14 made of a porous material housed in a casing 17. The base body 14 features a central milk passageway 15 as well as an annular air chamber 16 coaxially surrounding the milk passageway. The annular chamber 16 can be pumped by the pump 10 so that air can be jetted through the base body 14 into the milk passageway 15 to blend with the throughflow of milk. The substantially cylindrical base body 14 comprises a partition 14a defining the main passageway. It is understood that the whole base body 14 must not necessarily be made of a porous material, it being sufficient when just the cylindrical partition 14a is configured porous.

The functioning of the milk frother will now be detailled:

Pressing the button 13a starts frothing, this activating both the milk pump 5 and the continuous-flow heater 6 so that the milk forwarded from the milk receptacle 3 is heated in the continuous-flow heater 6 to then flow into the blender element 1. At the same time the pump 10 is activated, resulting in air being jetted into the annular air chamber 16 of the blender element 1. Preferably the pump 10 is activated together with the milk pump 5 so that the milk flowing into the blender element 1 is jetted with air right from the start.

Since the milk flowing into the blender element 1 has already been heated to a predetermined temperature, air is jetted into hot milk. The temperature of the heated milk at the outlet of the continuous-flow heater 6 can be sensed by means of the temperature sensor 7 and tweaked to any predetermined final temperature by means of the controller 13. The milk is usually heated in the continuous-flow heater 6 to a temperature in the range of approximately 60° C. to 70° C. Due to the porous configuration of the base body 14 the milk is jetted with air in minute quantities at innumeral locations in flowing through the base body 14. Air-jetting the milk results in air being instantly blended in the hot milk. But, in any case, a fine froth of milk is already made available at the outlet of the blender element 1. The diameter of the central milk passageway 15 is adapted to the rate of flow of the milk so that it flows with a predetermined velocity through the blender element 1, it being assured that just enough milk is forwarded through the central milk passageway 15 as is needed every time to ensure it is totally filled with milk. When correctly dimensioned the blender element 1 can be included in any position with no appreciable deteriment to the quality of the milk froth created. This is why it is irrelevant whether the blender element 1 has a vertical, horizontal or inclined throughflow of milk.

With the right choice of material of the base body 14 and correctly dimensioning the size of the pores it can be assured that the milk cannot appreciably enter the pores of the base body 14. The pores should preferably have a maximum diameter of approximately 0.3 mm. But, in any case, by suitably selecting the material of the base body 14 and adapting the pore size to the material and vice-versa the tendency of the base body 14 to become clogged can be reduced. The base body 14 is preferably made of a hydrophobic and/or oleophobic material, for example. PTFE (teflon). Producing the base body 14 is done, for example, by sintering.

Tests with a milk frother having such a configuration have demonstrated that a high-quality milk froth is now achievable already at the outlet of the blender element 1, i.e. there no longer being any need for downstream emulsifiers for homogenizing the milk, air and, where necessary, steam blend.

After creation of the milk froth the blender element 1 is flushed clean preferably by means of water, it, of course, making no sense to clean the blender element 1 after each and every frothing action when frothing is needed repeatedly in short intervals. This is why preferably a certain delay is instituted after each frothing action before cleaning can be started. Controlling cleaning may be likewise initiated by the controller 13.

Referring now to FIG. 1a there is illustrated a magnified view of a detail taken from FIG. 1 showing how air from the annular chamber 16 gains access through the porous base body 14 into the main passageway 15 where it is jetted from a plurality of perforations formed by the pores as indicated by the arrows 18. In the the instant example, air is metered jetted in minute quantities to the main passageway 15 and throughflow of milk respectively along a porrion a few centimeters long annularly over the full circumference. Because of air being metered jetted in minute quantities at innumeral locations in the throughflow of milk an homogenous and finely-porous milk froth is already created in the blender element 1. The size of the pores needs to be selected at least in the portion of the base body 14 bordering the blender element 1 so that the milk cannot enter the pores in any appreciable quantity, as already explained above.

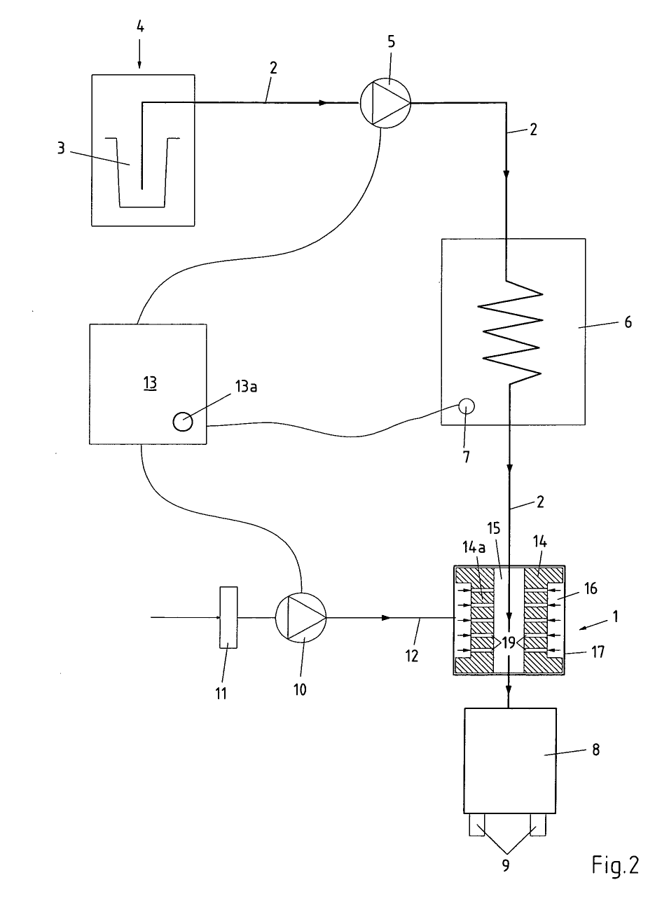

Referring now to FIG. 2 there is illustrated diagrammatically an alternative example aspect of a milk frother, the salient difference of which as compared to the previous example aspect being that the blender element 1 now comprises a base body 14 which is not made of a porous material, it instead being engineered with a plurality of passageways 19 via which the throughflow of milk can be jetted with air. The base body 14 in turn features a central milk passageway 15 as well as an annular air chamber 16 which can be pumped by means of the pump 10 and from which the cited passageways 19 extend radially through the base body 14 and partition 14a respectively into the central milk passageway 15. The base body 14 is preferably made of a hydrophobic and/or oleophobic material and the passageways 19 have preferably a maximum diameter of approximately 0.3 mm. This assures that the throughflow of milk cannot appreciably enter the passageways 19 under atmospheric conditions, i.e. when the annular air chamber 16 is not pumped. As an alternative, larger diameter passageways may also be provided, but in this case it needs to be assured that the annular air chamber 16 is always pumped when milk is pumped through the main passageway 15 so that the milk cannot enter the passageways also when these are provided larger. This is especially important for proper hygiene so that the milk cannot collect in the passageways 19, clogging them up.

However, the benefit of both aspect variants is that each is engineered relatively simple, involving relatively few single parts whilst assuring a high-quality, namely an homogenous, fine-porous and stable, milk froth with the added advantage of it being directly available at the outlet of the blender element 1, thus doing away with the need of a downstream emulsifier. As compared to conventional frothers there is now also hardly any need for valves or the like, thus enabling the frother to be engineered highly compact at low cost. On top of this, the milk frother has demonstrated itself to be uncritical to changes in the ambient conditions or in the operating parameters.

It is to be noted that instead of the electrically operated continuous-flow heater as described above, it is, of course, just as possible to use other means such as, for example, steam to heat the milk. But as regards the quality of the created milk froth it has proved to be of an advantage when the milk before being introduced into the blender element, i.e. before being jetted with air, that it brought up to the desired temperature, although it would be just as possible in principle to heat the milk not before having been jetted with air.

Due to the milk and air being automatically forwarded the absolute rate of flow per unit of time of milk and air, on the one hand, can be varied whilst, on the other, the ratio of milk to air can also be varied by, for example, incorporating an adjustable orifice in the air feed conduit 12.

1. A milk frother including a milk feed conduit (2), at least one means (6) for heating the milk as well as a blender element (1) provided with a main passageway (15) for blending the milk flowing through the main passageway (15) with the frothing medium, characterized in that the blender element (1) comprises a base body (14) with a plurality of perforations porting into the main passageway (15) via which the frothing medium is jettable into the throughflow of milk.

2. The milk frother as set forth in claim 1, characterized in that the base body (14) of the blender element (1) is made of a hydrophobic and/or oleophobic material.

3. The milk frother as set forth in claim 1, characterized in that the means (6) for heating the milk are circuited upstream of the blender element (1).

4. The milk frother as set forth in claim 1, characterized in that the diameter of the perforations porting into the main passageway (15) is selected so that the throughflow of milk cannot enter thereinto under atmospheric conditions.

5. The milk frother as set forth in claim 1, characterized in that the base body (14) comprises defining the main passageway (15) a partition (14a) in which said perforations are machined.

6. The milk frother as set forth in claim 1, characterized in that the base body (14) is configured cylindrical.

7. The milk frother as set forth in claim 1, characterized in that the main passageway (15) is machined in the base body (14) and the base body (14) is provided with an annular chamber (16) surrounding the main passageway (15) coaxially at least in part, the base body (14) being made of a porous material so that the air jetted into the annular chamber (16) can enter the main passageway (15) via the pores.

8. The milk frother as set forth in claim 1, characterized in that the perforations porting into the main passageway (15) have a maximum diameter of 0.3 mm.

9. The milk frother as set forth in claim 1, characterized in that the base body (14) of the blender element (1) is made by sintering.

10. The milk frother as set forth in claim 1, characterized in that it comprises a pump (10) for a pumped air feed, as well as an air filter (11) circuited upstream of the pump (10).

11. The milk frother as set forth in claim 1, characterized in that the means for heating the milk comprise an electrically operated continuous-flow heater (6) and a temperature sensor (7) for sensing the temperature of the heated milk.

12. A method for creating milk froth with a milk frother configured as set forth in any claim 1, characterized in that the milk flowing through the blender element (1) is jetted with air via the plurality of perforations.

13. The method as set forth in claim 12, characterized in that the milk is heated before being introduced into the blender element (1).

14. The method as set forth in claim 12, characterized in that the blender element (1) is jetted with air until the throughflow of the milk to be frothed through the blender element (1) is stopped.

15. The method as set forth in claim 12, characterized in that the air is introduced via the perforations into the main passageway (15) of the blender element (1) before the blender element (1) is supplied with the milk to be frothed and that the air feed is not stopped until the throughflow of milk through the blender element (1) has ceased.

16. The method as set forth in claim 12, characterized in that the before being introduced into the blender element (1) the milk is heated to a temperature of at least 30° C., particularly to at least 60° C.

17. An espresso coffee machine including a milk frother configured as set forth in claim 1.
